(19) United States
(12) Patent Application Publication
(10) Pub. No.: US 2025/0222782 A1
(43) Pub. Date: Jul. 10, 2025

(54) POWER STORAGE SYSTEM

(71) Applicant: HONDA MOTOR CO., LTD., Tokyo (JP)

(72) Inventors: Yasushi Ogihara, Saitama (JP); Yasuo Yamada, Saitama (JP); Katsuya Shimazaki, Saitama (JP); Shuji Kamata, Saitama (JP)

(73) Assignee: HONDA MOTOR CO., LTD., Tokyo (JP)

(21) Appl. No.: 19/006,268

(22) Filed: Dec. 31, 2024

(30) Foreign Application Priority Data
Jan. 9, 2024 (JP) 2024-001140

(51) Int. Cl. B60L 15/00; B60L 1/00; B60L 50/60; B60L 58/20; H02M 7/539

(52) U.S. Cl. CPC B60L 15/007; B60L 1/003; B60L 50/60; B60L 58/20; H02M 7/539; B60L 2220/50

(57) ABSTRACT

A power storage system includes: a battery including power storages, and a switch group capable of switching a connection state of the power storages between first, second and third voltage states as defined herein; a three-phase motor in which coils of three phases are connected at a neutral point, and which is driven by electric power supplied from the battery; an inverter connected between the battery and the three-phase motor; and a DC power supply circuit connected to a first connection portion positioned between the inverter and the battery, the DC power supply circuit on a positive electrode side has a branch circuit connected to one of the coils of three phases at a second connection portion via a first semiconductor switch, and a second semiconductor switch is provided, between the second connection portion and the inverter, in one of the coils of three phases.

### CROSS-REFERENCE TO RELATED APPLICATION

This application is based on and claims priority under 35 USC 119 from Japanese Patent Application No. 2024-001140 filed on Jan. 9, 2024.

### TECHNICAL FIELD

The present disclosure relates to a power storage system.

### BACKGROUND ART

In recent years, researches and developments have been conducted on charging and power feeding in a vehicle mounted with a secondary battery that contributes to an increase in energy efficiency in order to allow more users to access affordable, reliable, sustainable, and advanced energy.

In relation to charging and power supply in a vehicle including a secondary battery, there are two types of charging equipment such as charging stations: a 400 V class with an upper limit voltage of 500 V, and an 800 V class with an upper limit voltage of 1000V. When a vehicle is compatible with only the 400 V class charging equipment, the vehicle cannot enjoy quick charging performance of the 800 V class charging equipment.

In a case where the vehicle is both compatible with the 400 V class charging equipment and the 800 V class charging equipment, generally, a voltage is boosted to 800 V by a voltage converter when charging by the 400 V class charging equipment, or the voltage is stepped down to 400 V by the voltage converter when charging by the 800 V class charging equipment. However, using such a voltage converter for charging deteriorates efficiency during charging.

In this regard, there is known a vehicle in which a connection system of a battery module is switched so as to be chargeable by both the 400 V class charging equipment and the 800 V class charging equipment without using any voltage converter for charging (for example, JP2019-080474A and JP2020-150618A).

### SUMMARY OF INVENTION

By the way, there are two types of auxiliary devices used in a vehicle, one is driven at 400 V class and the other one is driven at 800 V class. In the vehicle in which the connection system of the battery module is switched, voltage conversion is generally performed by a voltage converter for auxiliary devices, for example, when a 400 V class auxiliary device is to be driven during charging by the 800 V class charging equipment, or when an 800 V class auxiliary device is to be driven during charging by the 400 V class charging equipment. However, such a voltage converter for auxiliary devices is expensive and thus a manufacturing cost increases.

In recent years, a charging method using a higher voltage and a lower current has been proposed in order to reduce a burden on a power distribution unit and terminals of a charging system for vehicles. In a 1200 V class charging equipment with an upper limit voltage of 1500 V, the burden on the power distribution unit and terminals of the charging system can be reduced as compared with 400 V class charging equipment and 800 V class charging equipment. For example, when an output of the charging equipment is 320 kW, theoretically, a current of 800 A flows in the 400 V class charging equipment, and a current of 400 A flows in the 800 V class charging equipment. On the other hand, in the 1200 V class charging equipment, a current can be decreased to 265 A.

In this way, for vehicles that can be charged by charging equipment with different upper limit voltages by switching a connection system of a battery module, there is a demand for a power storage system that can operate auxiliary devices without using expensive voltage converters for the auxiliary devices.

The present invention provides a power storage system capable of being efficiently charged according to a voltage state of charging equipment while reducing a manufacturing cost.

A power storage system according to one aspect of the present invention includes:
a battery including a plurality of power storage units, and a switch group capable of switching a connection state of the plurality of power storage units between a first voltage state capable of charging at a first voltage, a second voltage state capable of charging at a second voltage higher than the first voltage, and a third voltage state capable of charging at a third voltage higher than the second voltage;
a three-phase motor in which coils of three phases are connected at a neutral point, the three-phase motor being driven by electric power supplied from the battery;
an inverter connected on an electric power transmission path between the battery and the three-phase motor; and
a DC power supply circuit connected to a first connection portion positioned on an electric power transmission path between the inverter and the battery, in which
the DC power supply circuit on a positive electrode side has a branch circuit connected to a coil of any one phase among the coils of three phases at a second connection portion via a first semiconductor switch, and
a second semiconductor switch is provided between the second connection portion and the inverter in a coil of any one phase among the coils of three phases.

According to the present invention, the power storage system can be efficiently charged according to a voltage state of charging equipment while reducing a manufacturing cost.

### BRIEF DESCRIPTION OF DRAWINGS

FIG. 1 is a diagram showing a configuration of a power storage system 1 according to a first embodiment;

FIG. 2 is a diagram showing a configuration of a battery 2;

FIG. 3 is a diagram showing a configuration of an inverter 5 of the power storage system 1 of FIG. 1;

FIG. 4 is a diagram showing a first voltage state (400 V start-up state) of the battery 2;

FIG. 5 is a diagram showing a second voltage state (800 V start-up state) of the battery 2;

FIG. 6 is a diagram showing a third voltage state (1200 V start-up state) of the battery 2;

FIG. 7 is a diagram showing a flow of a current during traveling of an electric vehicle including the power storage system 1 according to a first embodiment;

FIG. 8 is a diagram showing a flow of a current during charging at a first voltage (400 V) of the electric vehicle including the power storage system 1 according to the first embodiment;

FIG. 9 is a diagram illustrating a boost operation of the inverter 5;

FIG. 10 is a diagram illustrating the boost operation of the inverter 5;

FIG. 11 is a diagram showing a flow of a current during charging at a second voltage (800 V) of the electric vehicle including the power storage system 1 according to the first embodiment;

FIG. 12 is a diagram showing a flow of a current during charging at a third voltage (1200 V) of the electric vehicle including the power storage system 1 according to the first embodiment;

FIG. 13 is a diagram illustrating a step-down operation of the inverter 5;

FIG. 14 is a diagram illustrating the step-down operation of the inverter 5;

FIG. 15 is a table summarizing states of switches and contactors in each mode of the power storage system 1 of the first embodiment;

FIG. 16 is a flowchart showing a control flow of the power storage system 1;

FIG. 17 is a diagram showing a configuration of the power storage system 1 according to a second embodiment;

FIG. 18 is a diagram showing a flow of a current during traveling of the electric vehicle including the power storage system 1 according to the second embodiment;

FIG. 19 is a diagram showing a flow of a current during charging at the first voltage (400 V) of the electric vehicle including the power storage system 1 according to the second embodiment;

FIG. 20 is a diagram showing a flow of a current during charging at the second voltage (800 V) of the electric vehicle including the power storage system 1 according to the second embodiment;

FIG. 21 is a diagram showing a flow of a current during charging at the third voltage (1200 V) of the electric vehicle including the power storage system 1 according to the second embodiment; and

FIG. 22 is a table summarizing states in each mode of the power storage system 1 of the second embodiment.

### DETAILED DESCRIPTION OF THE INVENTION

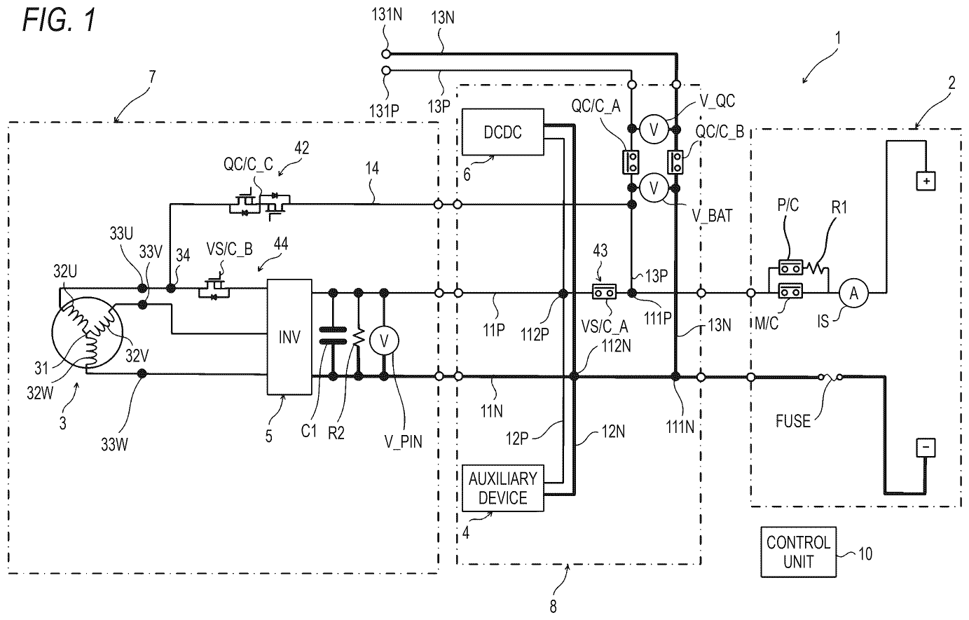

Hereinafter, embodiments of the present invention will be described with reference to the drawings. First, a first embodiment of the present invention will be described with reference to FIGS. 1 to 16.

### First Embodiment

A power storage system 1 according to the first embodiment shown in FIG. 1 is mounted on an electric vehicle such as an electric automobile. The electric vehicle including the power storage system 1 is compatible with charging equipment of 400 V class with an upper limit voltage of 500 V, 800 V class with an upper limit voltage of 1000 V, and 1200 V class with an upper limit voltage of 1500 V. The electric vehicle 1 not only can quickly charge a battery 2 at charge voltages of 400 V, 800 V, and 1200 V but also can drive a three-phase motor 3 and an auxiliary device 4 at a base voltage of 800 V. Note that the charge voltages of 400 V, 800 V, and 1200 V are merely examples, and the power storage system 1 is not limited by these voltages, and the charge voltages may be any voltages as long as charging by charging equipment with different upper limit voltages is possible.

Specifically, as shown in FIG. 1, the power storage system 1 includes the battery 2, the three-phase motor 3, the auxiliary device 4, an inverter 5 (INV), a DC-DC converter 6, electric power supply circuits 11P and 11N, auxiliary device drive circuits 12P and 12N, DC power supply circuits 13P and 13N, a branch circuit 14, and a control unit 10. In FIG. 1, reference numeral 7 denotes a drive unit, and reference numeral 8 denotes an auxiliary unit.

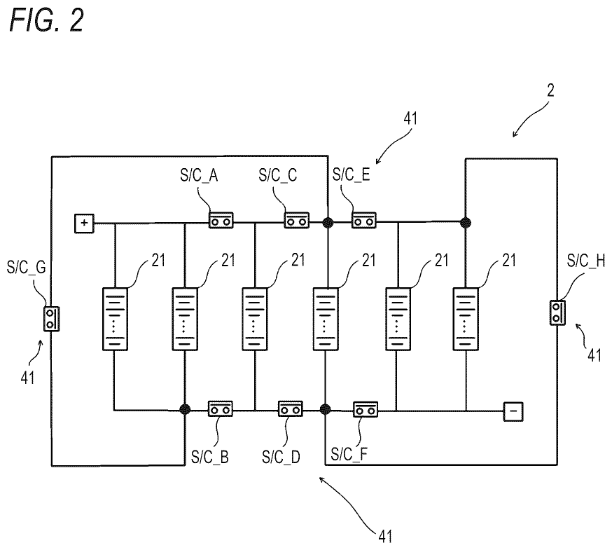

As shown in FIGS. 1 and 2, the battery 2 includes six power storage units 21, a first switch unit 41, a first contactor M/C, a pre-charge contactor P/C, a first resistor R1, a current sensor IS, and a current breaker FUSE.

The power storage units 21 are battery modules which can be charged and supply power at 400 V.

The first contactor M/C is provided on a positive electrode side end of the battery 2 and functions as a main switch which turns on and off connection to the outside (the electric power supply circuit 11P) of the battery 2.

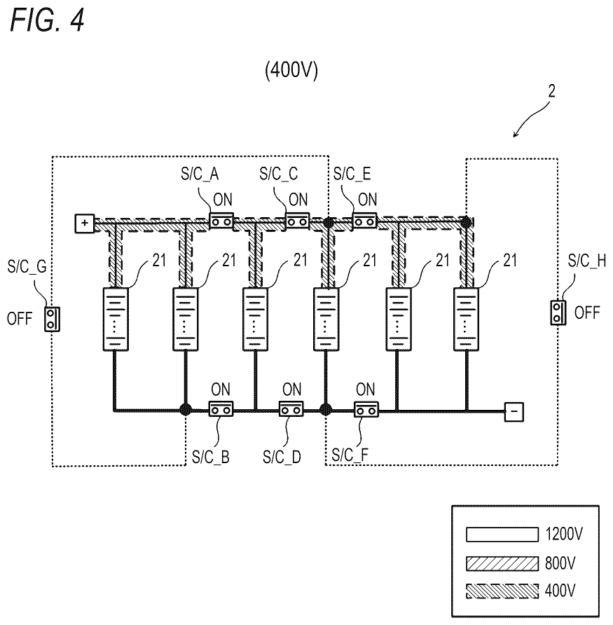

As shown in FIG. 2, the first switch unit 41 includes, for example, eight switches (S/C_A, S/C_B, S/C_C, S/C_D, S/C_E, S/C_F, S/C_G, and S/C_H). The eight switches constitute an example of a switch group, and switch a connection state of the six power storage units 21 of the battery 2. In a first voltage state shown in FIG. 4 in which the six power storage units 21 are connected in parallel, the battery 2 can be charged and supply power at 400 V. Hereinafter, this first voltage state capable of charging and supplying power at 400 V will also be referred to as a 400 V start-up state.

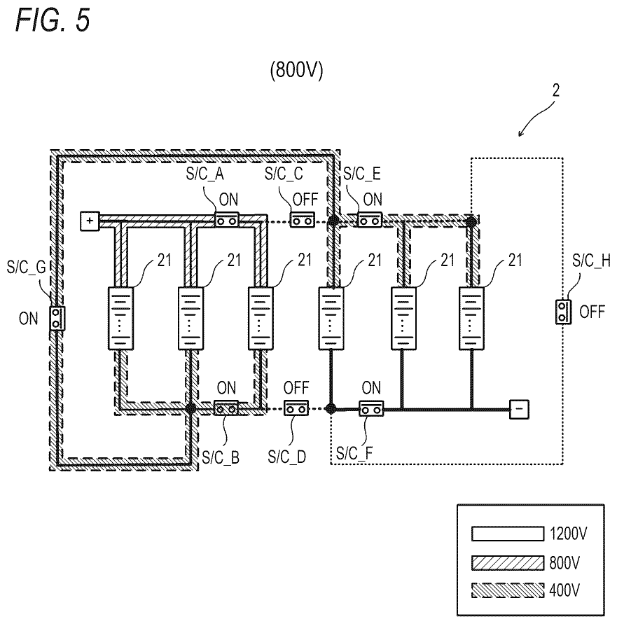

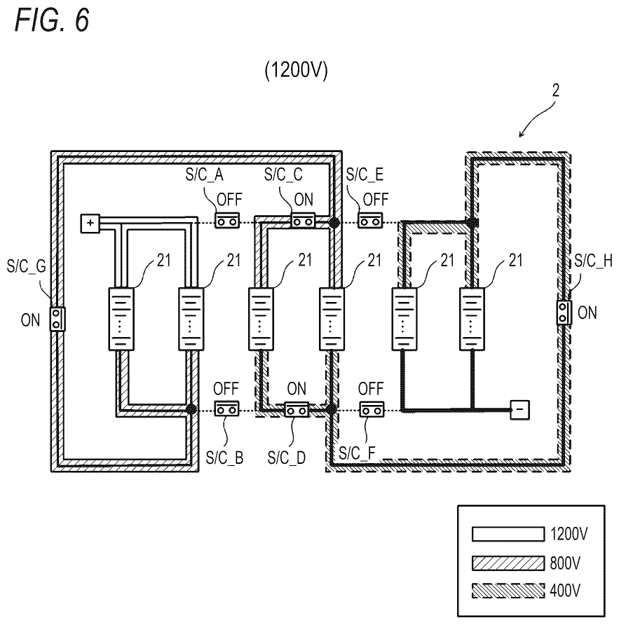

In a second voltage state shown in FIG. 5 in which two groups of three power storage units 21 connected in parallel are connected in series with each other, the battery 2 can be charged and supply power at 800 V. Hereinafter, this second voltage state capable of charging and supplying power at 800 V will also be referred to as an 800 V start-up state. Furthermore, in a third voltage state shown in FIG. 6 in which three groups of two power storage units 21 connected in parallel are connected in series with each other, the battery 2 can be charged and supply power at 1200 V. Hereinafter, this third voltage state capable of charging and supplying power at 1200 V will also be referred to as a 1200 V start-up state.

Returning to FIG. 1, the pre-charge contactor P/C and the first resistor R1 are arranged in series with each other and in parallel with the first contactor M/C. When pre-charging a smoothing capacitor C1, the pre-charge contactor P/C is turned on before the first contactor M/C is turned on, thereby protecting the first contactor M/C from an excessive inrush current. The pre-charge contactor P/C is maintained in an OFF state except when pre-charging the smoothing capacitor C1.

The current sensor IS is disposed between the first contactor M/C and the six power storage units 21, and measures currents.

The current breaker FUSE is provided on a negative electrode side end of the battery 2 and cuts off the connection to the outside (the electric power supply circuit 11N) of the battery 2 when an abnormality occurs. In the power storage system 1 according to the present embodiment, the current breaker FUSE is implemented by a pyro-fuse which can intentionally cut off a current according to an electrical signal. When an abnormality occurs (for example, vehicle collision or a short circuit in the battery 2), the current breaker FUSE performs a cut-off operation, and all the contactors in the battery 2 are turned off (opened).

The three-phase motor 3 includes coils 32U, 32V, and 32 W of three phases, one end side of each of which is connected to a neutral point 31, and is rotationally driven by electric power supplied from the battery 2 via the inverter 5. The three-phase motor 3 in the present embodiment includes a U-phase terminal 33U, a V-phase terminal 33V, and a W-phase terminal 33 W connected to the other end side of each of the coils 32U, 32V, and 32 W, respectively. The U-phase terminal 33U, the V-phase terminal 33V, and the W-phase terminal 33 W are connected to the inverter 5. The other end side of a coil of any one phase among the coils 32U, 32V, 32 W is connected to the branch circuit 14 at a connection portion 34. In the present embodiment, the coil 32U among the coils 32U, 32V, and 32 W of three phases is connected to the branch circuit 14 at the connection portion 34 positioned between the U-phase terminal 33U and the inverter 5.

The U-phase coil 32U to which the branch circuit 14 is connected is provided with a fourth switch unit 44 between the connection portion 34 and the inverter 5. The fourth switch unit 44 is implemented by a second semiconductor switch VS/C_B. The second semiconductor switch VS/C_B turns on and off a circuit between the connection portion 34 and the inverter 5. The second semiconductor switch VS/C_B is implemented by, for example, a MOSFET disposed such that a body diode thereof is oriented in such a way that a current is allowed to flow back from the inverter 5 side to the three-phase motor 3 side. Therefore, when the second semiconductor switch VS/C_B is in an OFF state, a flow of a current from the connection portion 34 side to the inverter 5 side is cut off, and a flow of a current from the inverter 5 side to the connection portion 34 side is permitted. Note that the second semiconductor switch VS/C_B may be any semiconductor switch capable of high-frequency switching, and may be implemented by a bipolar transistor, an IGBT, or the like instead of a MOSFET.

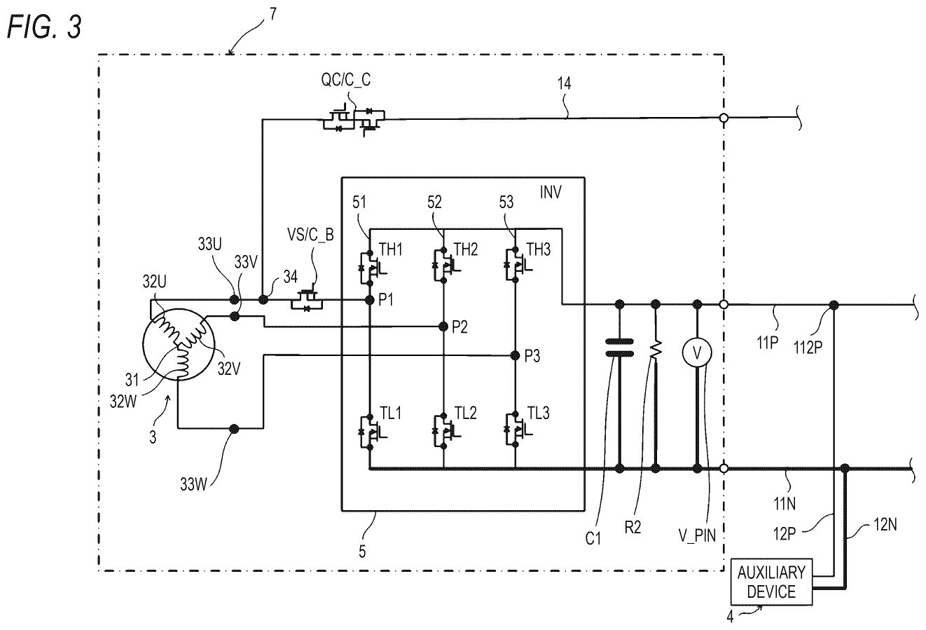

The inverter 5 converts DC power supplied from the battery 2 into three-phase AC power by switching a plurality of switching elements, so as to rotationally drive the three-phase motor 3. As shown in FIG. 3, the inverter 5 includes a first branch circuit 51 including a first high-side switch TH1, a first low-side switch TL1, and a first node P1 connecting the first high-side switch TH1 and the first low-side switch TL1 in series, a second branch circuit 52 including a second high-side switch TH2, a second low-side switch TL2, and a second node P2 connecting the second high-side switch TH2 and the second low-side switch TL2 in series, and a third branch circuit 53 including a third high-side switch TH3, a third low-side switch TL3, and a third node P3 connecting the third high-side switch TH3 and the third low-side switch TL3 in series. The first branch circuit 51, the second branch circuit 52, and the third branch circuit 53 have their high-side switch side ends connected in parallel with the electric power supply circuit 11P on the positive electrode side, and their low-side switch side ends connected in parallel with the electric power supply circuit 11N on the negative electrode side.

The first node P1 is connected to the U-phase terminal 33U and thereby connected to the coil 32U, the second node P2 is connected to the V-phase terminal 33V and thereby connected to the coil 32V, and the third node P3 is connected to the W-phase terminal 33W and thereby connected to the coil 32W. Note that the switches TH1, TL1, TH2, TL2, TH3, and TL3 are implemented by, for example, MOSFETs, whose opening and closing control is performed by the control unit 10 by adjusting a gate voltage.

A diode operating as a reflux diode is connected in parallel with each of the switches TH1, TL1, TH2, TL2, TH3, and TL3. The reflux diodes are provided to prevent damage to the switching elements by causing a current flowing back from a motor 24 side to reflux (regenerate) to a power supply 11 side when the switches TH1, TL1, TH2, TL2, TH3, and TL3 are turned off. That is, the inverter 5 allows a current to flow from the three-phase motor 3 side to the battery 2 side regardless of an ON or OFF state of a gate, and allows a current to flow from the battery 2 side to the three-phase motor 3 side only when the gate is in an ON state.

As will be described in detail later, when a voltage of 400 V is supplied from the branch circuit 14 to the connection portion 34, the power storage system 1 can cause the three-phase motor 3 to function as a part of a boost circuit by switching the switches TH1, TL1, TH2, TL2, TH3, and TL3. When a voltage of 1200 V is supplied from the branch circuit 14 to the connection portion 34, the three-phase motor 3 can function as a part of a step-down circuit by switching a first semiconductor switch QC/C_C (second switch unit 42), which will be described later, and the second semiconductor switch VS/C_B (fourth switch unit 44), and the switches TH1, TL1, TH2, TL2, TH3, and TL3.

The auxiliary device 4 is a high-voltage driven in-vehicle device which can be driven by DC power from the battery 2 and an external power supply, and examples thereof includes an electric compressor or a heater for air-conditioning. The auxiliary device 4 is connected to the battery 2 via auxiliary device drive circuits 12P and 12N, a third switch unit 43, and the electric power supply circuits 11P and 11N, which will be described later. The auxiliary device 4 according to the present embodiment operates at the base voltage of 800 V.

The DC-DC converter 6 steps down the DC power from the battery 2 and the external power supply to drive a low-voltage driven in-vehicle device.

The electric power supply circuits 11P and 11N are configured as a positive and negative pair and connect the battery 2 and the inverter 5 (three-phase motor 3). The electric power supply circuits 11P and 11N are provided with first connection portions 111P and 111N as connection portions with the DC power supply circuits 13P and 13N, and are provided with second connection portions 112P and 112N as connection portions with the auxiliary device drive circuits 12P and 12N (auxiliary device 4) on a side closer to the inverter 5 than the first connection portions 111P and 111N. The electric power supply circuit 11P on the positive electrode side is provided with the third switch unit 43 which turns on and off a circuit between the connection portion 112P connected to the auxiliary device drive circuit 12P and the connection portion 111P connected to the DC power supply circuit 13P. The third switch unit 43 is implemented by a second contactor VS/C_A. The second contactor VS/C_A is, for example, an electromagnetic contactor.

A first voltage sensor V_PIN, the smoothing capacitor C1 and a second resistor R2 are provided on the inverter 5 side of the electric power supply circuits 11P and 11N. The first voltage sensor V_PIN, the smoothing capacitor C1, and the second resistor R2 are provided on a circuit that connects the electric power supply circuit 11P on the positive electrode side and the electric power supply circuit 11N on the negative electrode side. Note that the second resistor R2 is provided to discharge the smoothing capacitor C1 when the circuit is cut off.

The DC power supply circuits 13P and 13N are configured as a positive and negative pair and include one end provided with charge terminals 131P and 131N to which an external power supply such as charging equipment can be connected and the other end connected to the electric power supply circuits 11P and 11N via the first connection portions 111P and 111N. The DC power supply circuits 13P and 13N are provided with a third contactor QC/C_A and a fourth contactor QC/C_B for turning on and off the circuits, respectively. A second voltage sensor V_BAT is provided at a position closer to the first connection portions 111P and 111N than the third contactor QC/C_A and the fourth contactor QC/C_B. A third voltage sensor V_QC is provided at a position closer to the charge terminals 131P and 131N than the third contactor QC/C_A and the fourth contactor QC/C_B.

The branch circuit 14 is branched, in the DC power supply circuit 13P on the positive electrode side, at a position closer to the connection portion 111P than the third contactor QC/C_A and the second voltage sensor V_BAT and is connected to one of the coils of the three-phase motor 3 via the connection portion 34. An intermediate portion of the branch circuit 14 is provided with a second switch unit 42 for turning on and off the circuit. The second switch unit 42 is implemented by the first semiconductor switch QC/C_C. The first semiconductor switch QC/C_C includes MOSFETs arranged in series such that body diodes thereof are oriented in opposite directions. Therefore, when the first semiconductor switch QC/C_C is in an OFF state, the current flowing through the branch circuit 14 is cut off by the first semiconductor switch QC/C_C. Note that the first semiconductor switch QC/C_C may be any semiconductor switch capable of high-frequency switching, and may be implemented by a bipolar transistor, an IGBT, or the like instead of a MOSFET.

The control unit 10 is, for example, a vehicle ECU and controls driving and charging of the power storage system 1. More specifically, the control unit 10 controls the ON/OFF state of the first to fourth switch units 41 to 44 and each contactor (including PWM control), controls the DC-DC converter 6, and controls the inverter 5.

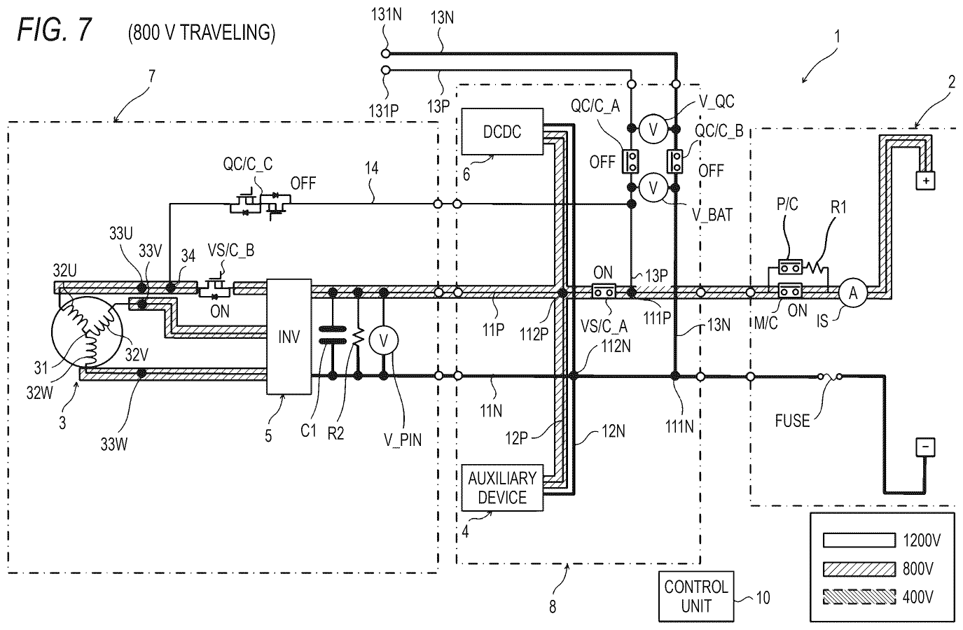

Next, an operation of the power storage system 1 will be described with reference to FIGS. 7 to 14.

FIG. 7 is a diagram showing a flow of a current during traveling (800 V traveling) of an electric vehicle including the power storage system 1 according to the first embodiment.

As described above, the electric vehicle including the power storage system 1 drives the three-phase motor 3 and the auxiliary device 4 with the base voltage of 800 V, and during traveling, the battery 2 is controlled to the 800 V start-up state shown in FIG. 5. The control unit 10 turns on the first contactor M/C, the second contactor VS/C_A (third switch unit 43), and the second semiconductor switch VS/C_B (fourth switch unit 44), and turns off the third contactor QC/C_A, the fourth contactor QC/C_B, and the first semiconductor switch QC/C_C (second switch unit 42). A circuit mode in this case is called a first mode.

In this first mode, a voltage of 800 V is supplied from the battery 2 to the three-phase motor 3 via the inverter 5, enabling the electric vehicle to travel. In this case, the auxiliary device 4 is driven by a voltage of 800 V supplied from the battery 2 via the electric power supply circuits 11P and 11N and the auxiliary device drive circuits 12P and 12N.

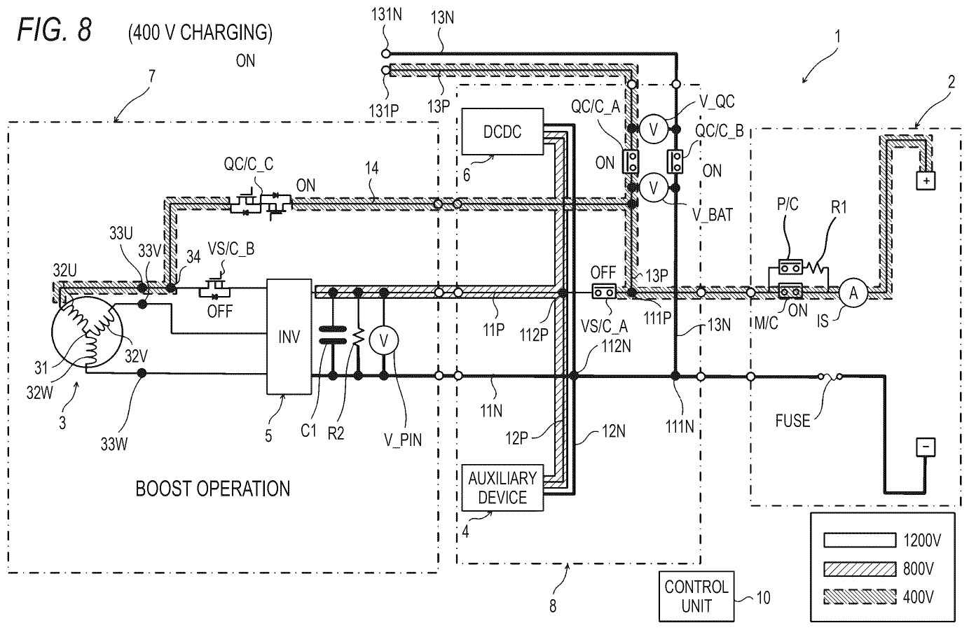

FIG. 8 is a diagram showing a flow of a current during charging at the first voltage (400 V charging) of the electric vehicle including the power storage system 1 according to the first embodiment.

When charging with a 400 V class charging equipment, the battery 2 is controlled to a 400 V start-up state shown in FIG. 4. The control unit 10 turns on the first contactor M/C, the third contactor QC/C_A, the fourth contactor QC/C_B, and the first semiconductor switch QC/C_C (second switch unit 42), and turns off the second contactor VS/C_A (third switch unit 43) and the second semiconductor switch VS/C_B (fourth switch unit 44). A circuit mode in this case is called a fourth mode. As a result, a voltage of 400 V is supplied from the charge terminals 131P and 131N to the battery 2, and a voltage of 400 V is supplied via the branch circuit 14 to the coil 32U.

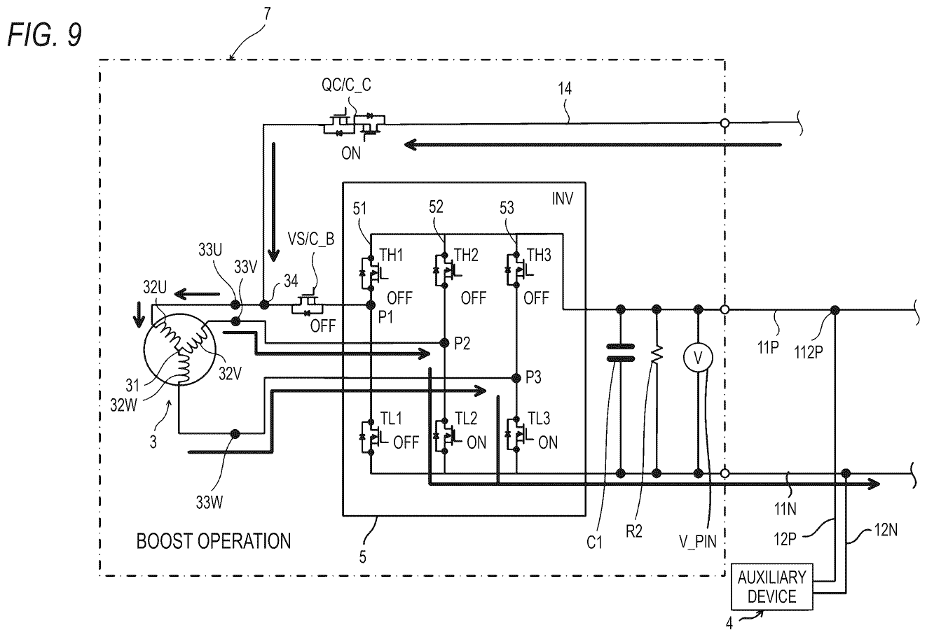

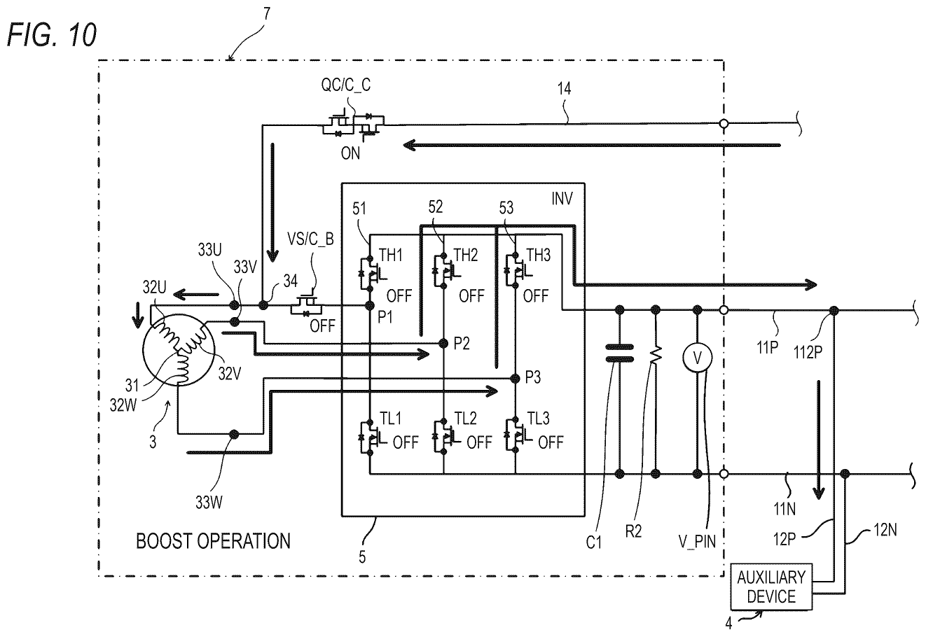

Here, in order to drive the auxiliary device 4 having a base voltage of 800 V, it is necessary to boost the voltage of 400 V to 800 V, which is the base voltage of the auxiliary device 4. Therefore, with the first semiconductor switch QC/C_C (second switch unit 42) turned on and the second semiconductor switch VS/C_B (fourth switch unit 44) turned off, the control unit 10 performs high-frequency switching of the second low-side switch TL2 and the third low-side switch TL3 to perform a boost operation to switch between an ON state of the second low-side switch TL2 and the third low-side switch TL3 shown in FIG. 9 and an OFF state of the second low-side switch TL2 and the third low-side switch TL3 shown in FIG. 10. Note that the other switches TL1, and TH1 to TH3 of the inverter 5 are maintained in an OFF state.

As a result, the energy stored in the coils 32U, 32V, and 32W when the second low-side switch TL2 and the third low-side switch TL3 are in the ON state shown in FIG. 9 is released when the second low-side switch TL2 and the third low-side switch TL3 are in the OFF state shown in FIG. 10, so that the voltage of 400 V supplied from the charge terminals 131P and 131N is boosted to 800 V and supplied from the inverter 5 to the auxiliary device 4.

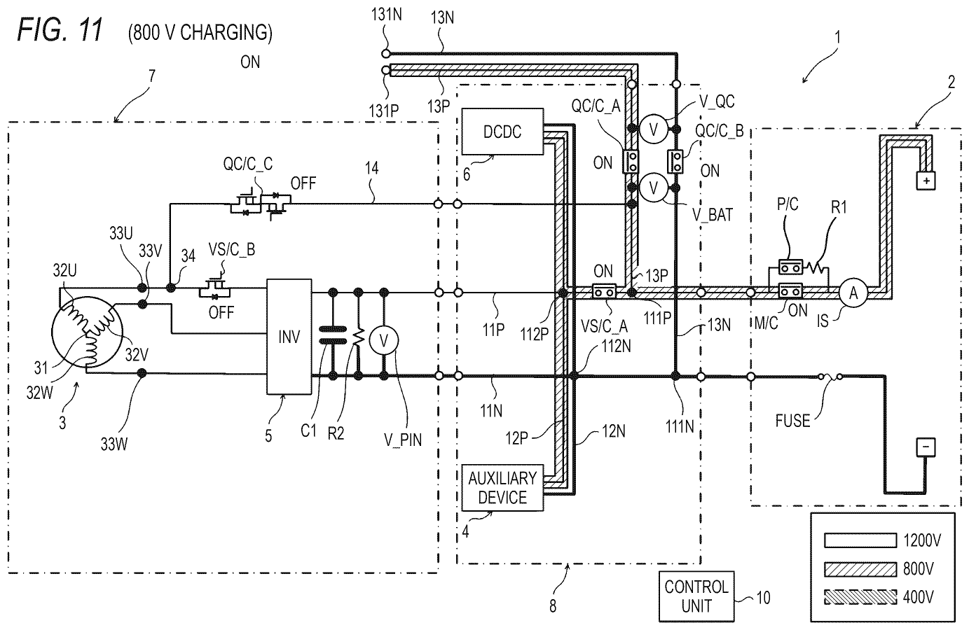

FIG. 11 is a diagram showing a flow of a current during charging at the second voltage (800 V charging) of the electric vehicle including the power storage system 1 according to the first embodiment.

When charging with an 800 V class charging equipment, the battery 2 is controlled to an 800 V start-up state shown in FIG. 5. The control unit 10 turns on the first contactor M/C, the third contactor QC/C_A, the fourth contactor QC/C_B, and the second contactor VS/C_A (third switch unit 43), and turns off the second semiconductor switch VS/C_B (fourth switch unit 44) and the first semiconductor switch QC/C_C (second switch unit 42). A circuit mode in this case is called a third mode. As a result, a voltage of 800 V is supplied from the charge terminals 131P and 131N to the battery 2, and a voltage of 800 V is supplied to the auxiliary device 4 via the electric power supply circuit 11P and the auxiliary device drive circuit 12P.

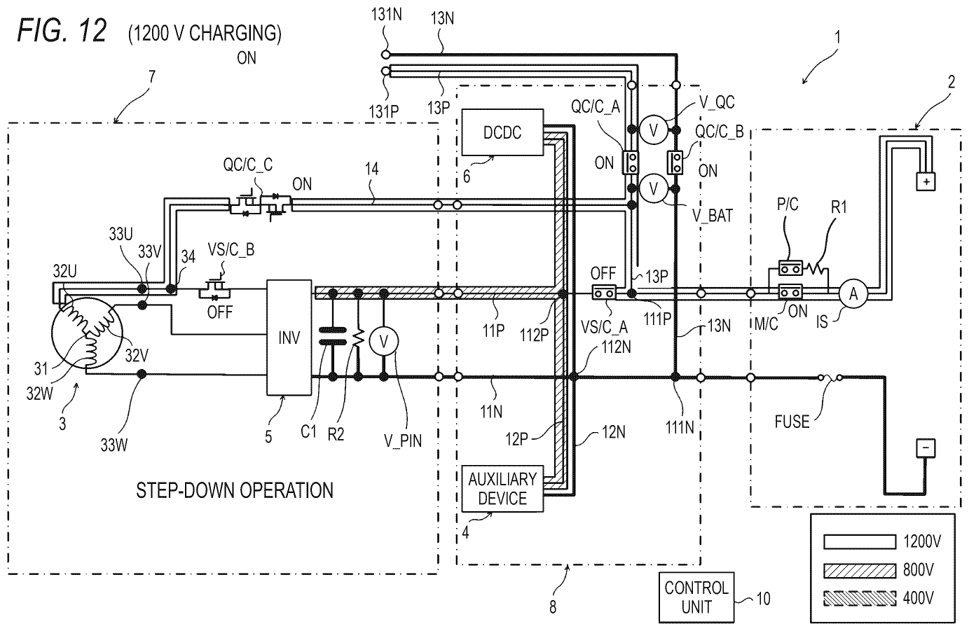

FIG. 12 is a diagram showing a flow of a current during charging at the third voltage (1200 V charging) of the electric vehicle including the power storage system 1 according to the first embodiment.

When charging with a 1200 V class charging equipment, the battery 2 is controlled to a 1200 V start-up state shown in FIG. 6. The control unit 10 turns on the first contactor M/C, the third contactor QC/C_A, the fourth contactor QC/C_B, and the first semiconductor switch QC/C_C (second switch unit 42), and turns off the second contactor VS/C_A (third switch unit 43) and the second semiconductor switch VS/C_B (fourth switch unit 44). A circuit mode in this case is called a second mode. As a result, a voltage of 1200 V is supplied from the charge terminals 131P and 131N to the battery 2, and a voltage of 1200 V is supplied via the branch circuit 14 to the coil 32U.

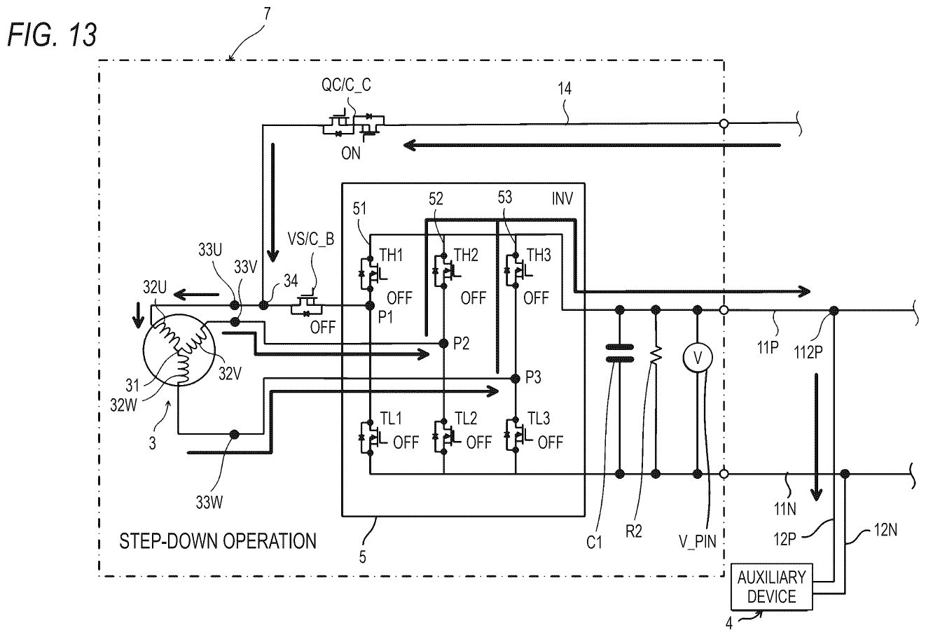

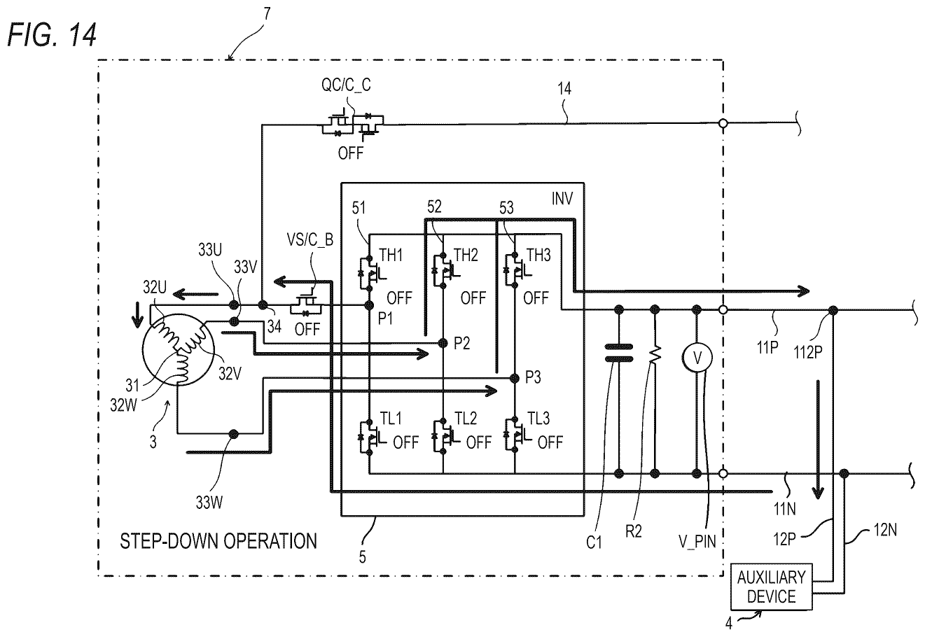

Here, in order to drive the auxiliary device 4 having a base voltage of 800 V, it is necessary to step down the voltage of 1200 V to 800 V, which is the base voltage of the auxiliary device 4. Therefore, the control unit 10 performs high-frequency switching of the first semiconductor switch QC/C_C (second switch unit 42) to perform a step-down operation to switch between the ON state of the first semiconductor switch QC/C_C (second switch unit 42) shown in FIG. 13 and the OFF state of the first semiconductor switch QC/C_C (second switch unit 42) shown in FIG. 14. In this case, the second semiconductor switch VS/C_B (fourth switch unit 44) and the switches TL1 to TL3 and TH1 to TH3 of the inverter 5 are maintained in the OFF state.

As a result, the energy stored in the coils 32U, 32V, and 32 W when the first semiconductor switch QC/C_C (second switch unit 42) is in the ON state shown in FIG. 13 is released when the first semiconductor switch QC/C_C (second switch unit 42) is in the OFF state shown in FIG. 14, so that the voltage of 1200 V supplied from the charge terminals 131P and 131N is stepped down to 800 V and supplied from the inverter 5 to the auxiliary device 4.

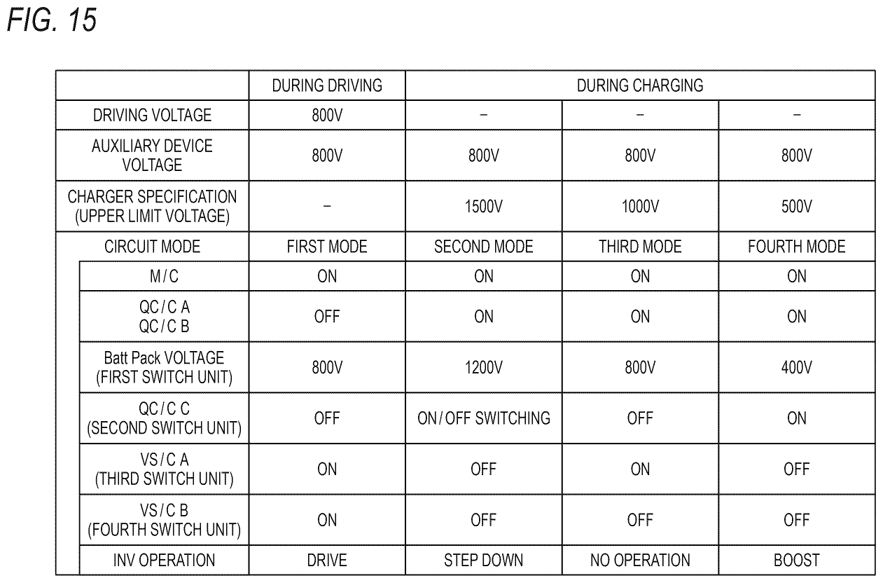

FIG. 15 is a table summarizing the states of the switches and the contactors in each mode of the power storage system 1 of the first embodiment.

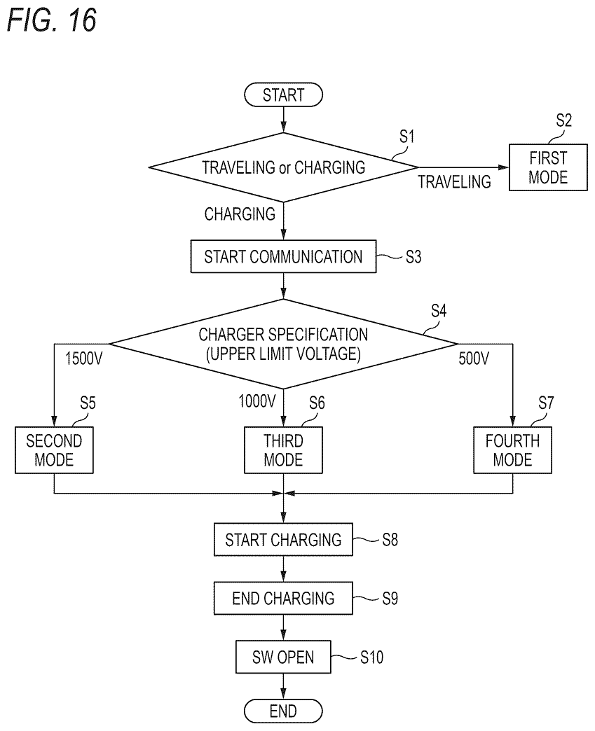

FIG. 16 is a flowchart showing a control flow of the power storage system 1.

First, it is detected whether the electric vehicle including the power storage system 1 is in a traveling mode or a charging mode (step S1). In the charging mode, a charging plug is inserted into the charge terminals 131P and 131N. In the traveling mode, for example, a user presses a power switch while depressing a brake pedal of the electric vehicle. If the traveling mode is detected in step S1, the circuit mode of the power storage system 1 is set to the first mode (step S2).

On the other hand, if the charging mode is detected in step S1, the control unit 10 starts communication with the charging equipment (step S3) and acquires charger specifications of the charging equipment (step S4). If an upper limit voltage of the charger is 1500 V in step S4, the circuit mode of the power storage system 1 is set to the second mode (step S5); if the upper limit voltage is 1000 V, the circuit mode of the power storage system 1 is set to the third mode (step S6); and if the upper limit voltage is 500 V, the circuit mode of the power storage system 1 is set to the fourth mode (step S7).

When the mode setting of the power storage system 1 is completed, charging is started (step S8), and when charging is completed (step S9), all the switches and contactors of the power storage system 1 are turned off to end the processing (step S9).

In this way, according to the power storage system 1 of the first embodiment, regardless of whether the external charging equipment is a system that charges at the first voltage (400 V charging), a system that charges at the second voltage (800 V charging), or a system that charges at the third voltage (1200 V charging), a connection method of the plurality of power storage units 21 can be switched using the first switch unit 41 (S/C_A, S/C_B, S/C_C, S/C_D, S/C_E, S/C_F, S/C_G, S/C_H), thereby enabling appropriate charging according to the voltage state of the charging equipment. That is, charging can be performed without passing through any voltage converter during charging, and therefore, efficiency deterioration due to a voltage converter can be avoided, and it is possible to eliminate a voltage converter for charging.

Since the DC power supply circuit 13P on the positive electrode side connected to the first connection portion 111P positioned on the electric power transmission path between the inverter 5 and the battery 2 includes the branch circuit 14 connected to a coil of any one phase of the three-phase motor 3, voltage conversion can be performed using the three-phase motor 3 and the inverter 5. Especially, by providing the first semiconductor switch QC/C_C (second switch unit 42) and the second semiconductor switch VS/C_B (fourth switch unit 44), it is possible to not only boost but also step down the voltage by utilizing the coils of the three-phase motor 3, even when the voltage state of the charging equipment and the operating voltage of the auxiliary device 4 are different from each other. In this way, a dedicated voltage converter can be eliminated, thereby reducing the manufacturing cost.

### Second Embodiment

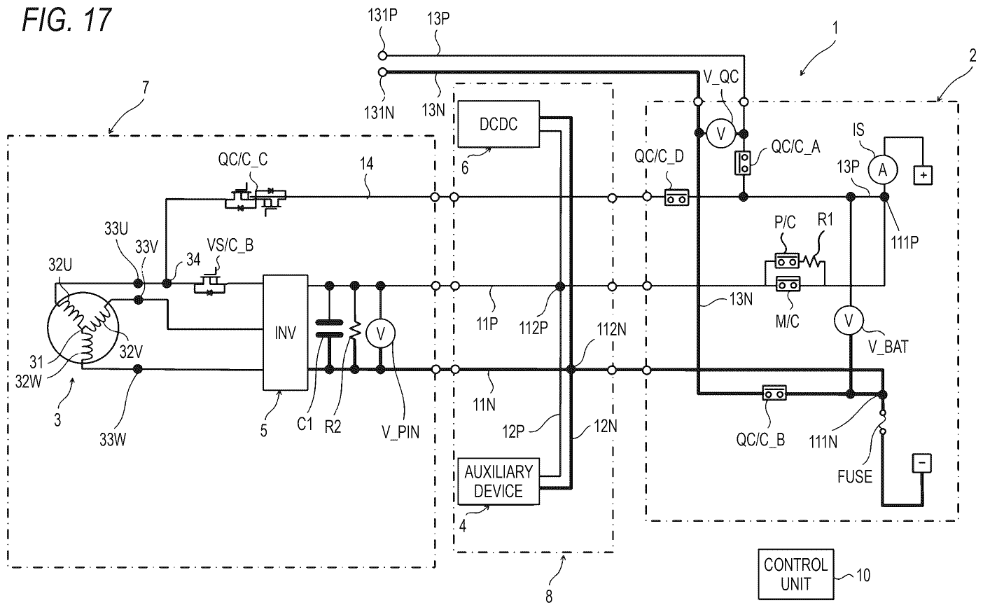

Next, the power storage system 1 according to the second embodiment will be described with reference to FIGS. 17 to 22. Here, the same reference numerals as in the first embodiment are used for the same configurations as in the first embodiment, and the description of the first embodiment may be incorporated.

In the power storage system 1 according to the first embodiment, the third contactor QC/C_A which is a main switch for charging is connected in series to the first contactor M/C which is a main switch of the battery 2. However, in the power storage system 1 according to the second embodiment, the third contactor QC/C_A is connected in parallel with the first contactor M/C as shown in FIG. 17.

In the power storage system 1 according to the second embodiment, during charging with the first voltage (400 V) or the third voltage (1200 V), the battery 2 charged with the first voltage (400 V) or the third voltage (1200 V) can be separated, by the first contactor M/C, from the second voltage (800 V) boosted by the three-phase motor 3 and the inverter 5, and thus the second contactor VS/C_A of the first embodiment is no longer required. Instead, a fifth contactor QC/C_D that turns on and off the branch circuit 14 is provided in an intermediate portion of the branch circuit 14 closer to the DC power supply circuit 13P side than the first semiconductor switch QC/C_C. In the power storage system 1 according to the second embodiment, the third contactor QC/C_A, the fourth contactor QC/C_B, the fifth contactor QC/C_D, the second voltage sensor V_BAT, and the third voltage sensor V_QC are arranged in the battery 2.

The second embodiment is similar to the first embodiment in that eight switches (S/C_A, S/C_B, S/C_C, S/C_D, S/C_E, S/C_F, S/C_G, S/C_H) constitute an example of the first switch unit 41, the first semiconductor switch QC/C_C is an example of the second switch unit 42, and the second semiconductor switch VS/C_B is an example of the fourth switch unit 44, and differs from the first embodiment in that the first contactor M/C is an example of the third switch unit 43.

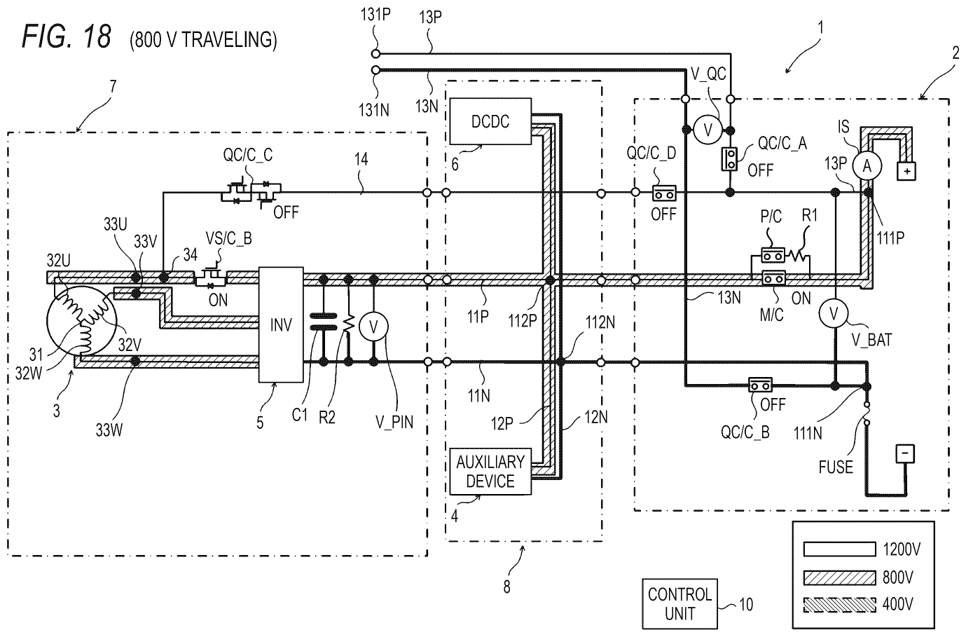

An operation of the power storage system 1 according to the second embodiment will be described with reference to FIGS. 18 to 21.

FIG. 18 is a diagram showing a flow of a current during traveling (800 V traveling) of an electric vehicle including the power storage system 1 according to the second embodiment.

As described above, the electric vehicle including the power storage system 1 drives the three-phase motor 3 and the auxiliary device 4 with the base voltage of 800 V, and during traveling, the battery 2 is controlled to the 800 V start-up state shown in FIG. 5. The control unit 10 turns on the first contactor M/C (third switch unit 43) and the second semiconductor switch VS/C_B (fourth switch unit 44), and turns off the third contactor QC/C_A, the fourth contactor QC/C_B, the first semiconductor switch QC/C_C (second switch unit 42), and the fifth contactor QC/C_D. A circuit mode in this case is called an eleventh mode.

In this eleventh mode, a voltage of 800 V is supplied from the battery 2 to the three-phase motor 3 via the inverter 5, enabling the electric vehicle to travel. In this case, the auxiliary device 4 is driven by a voltage of 800 V supplied from the battery 2 via the electric power supply circuits 11P and 11N and the auxiliary device drive circuits 12P and 12N.

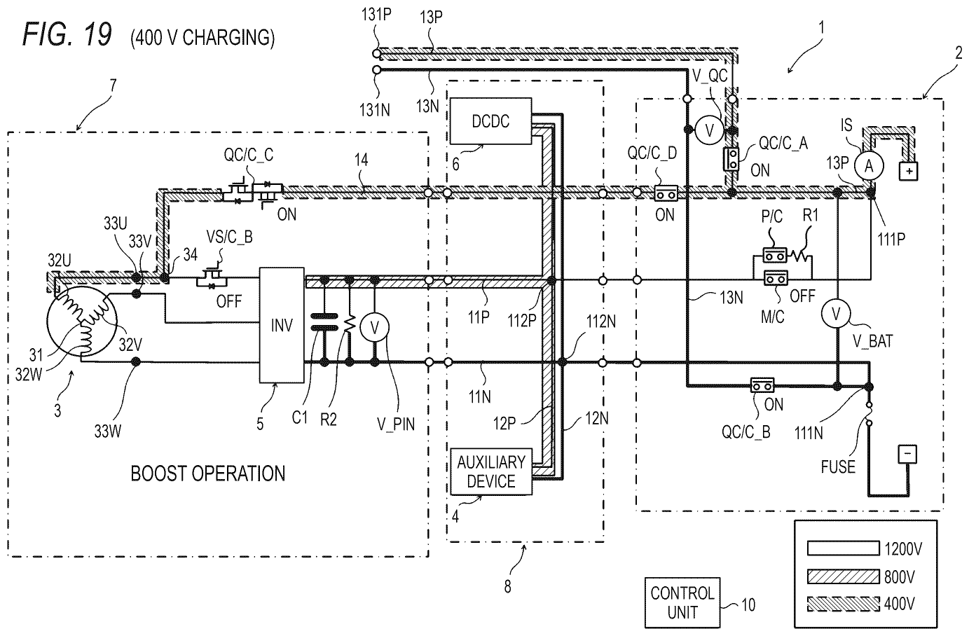

FIG. 19 is a diagram showing a flow of a current during charging at the first voltage (400 V charging) of the electric vehicle including the power storage system 1 according to the second embodiment.

When charging with a 400 V class charging equipment, the battery 2 is controlled to a 400 V start-up state shown in FIG. 4. The control unit 10 turns on the third contactor QC/C_A, the fourth contactor QC/C_B, the first semiconductor switch QC/C_C (second switch unit 42), and the fifth contactor QC/C_D, and turns off the first contactor M/C (third switch unit 43) and the second semiconductor switch VS/C_B (fourth switch unit 44). A circuit mode in this case is called a fourteenth mode. As a result, a voltage of 400 V is supplied from the charge terminals 131P and 131N to the battery 2, and a voltage of 400 V is supplied via the branch circuit 14 to the coil 32U.

Here, in order to drive the auxiliary device 4 having a base voltage of 800 V, it is necessary to boost the voltage of 400 V to 800 V, which is the base voltage of the auxiliary device 4. The boost operation is as explained in the first embodiment with reference to FIGS. 9 and 10, and detailed explanation thereof will be omitted. By the boost operation, the voltage of 400 V supplied from the charge terminals 131P and 131N is boosted to 800 V and supplied from the inverter 5 to the auxiliary device 4.

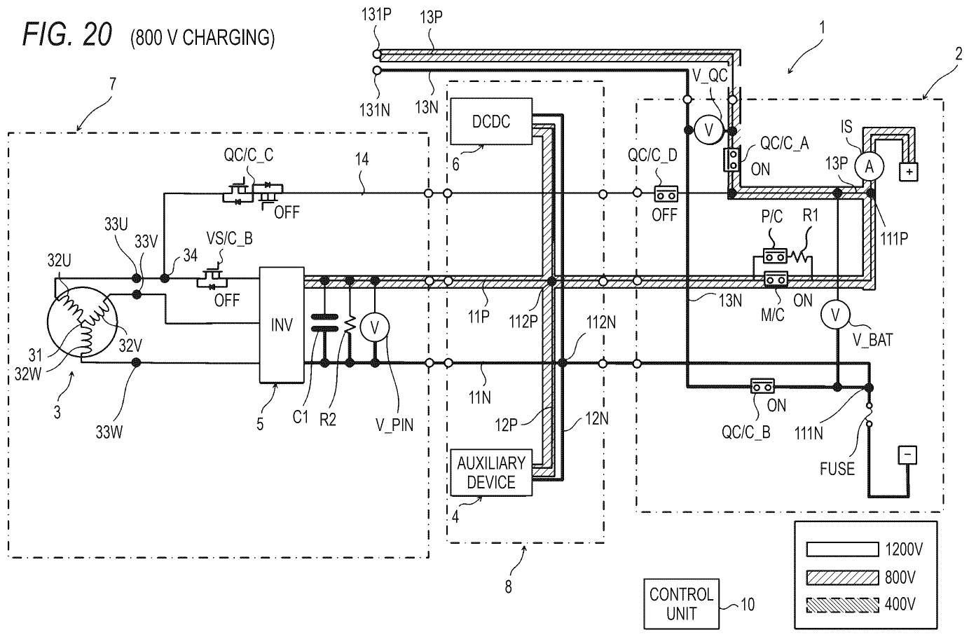

FIG. 20 is a diagram showing a flow of a current during charging at the second voltage (800 V charging) of the electric vehicle including the power storage system 1 according to the second embodiment.

When charging with an 800 V class charging equipment, the battery 2 is controlled to an 800 V start-up state shown in FIG. 5. The control unit 10 turns on the first contactor M/C (third switch unit 43), the third contactor QC/C_A, and the fourth contactor QC/C_B, and turns off the second semiconductor switch VS/C_B (fourth switch unit 44), the first semiconductor switch QC/C_C (second switch unit 42), and the fifth contactor QC/C_D. A circuit mode in this case is called a thirteenth mode. As a result, a voltage of 800 V is supplied from the charge terminals 131P and 131N to the battery 2, and a voltage of 800 V is supplied to the auxiliary device 4 via the electric power supply circuit 11P and the auxiliary device drive circuit 12P.

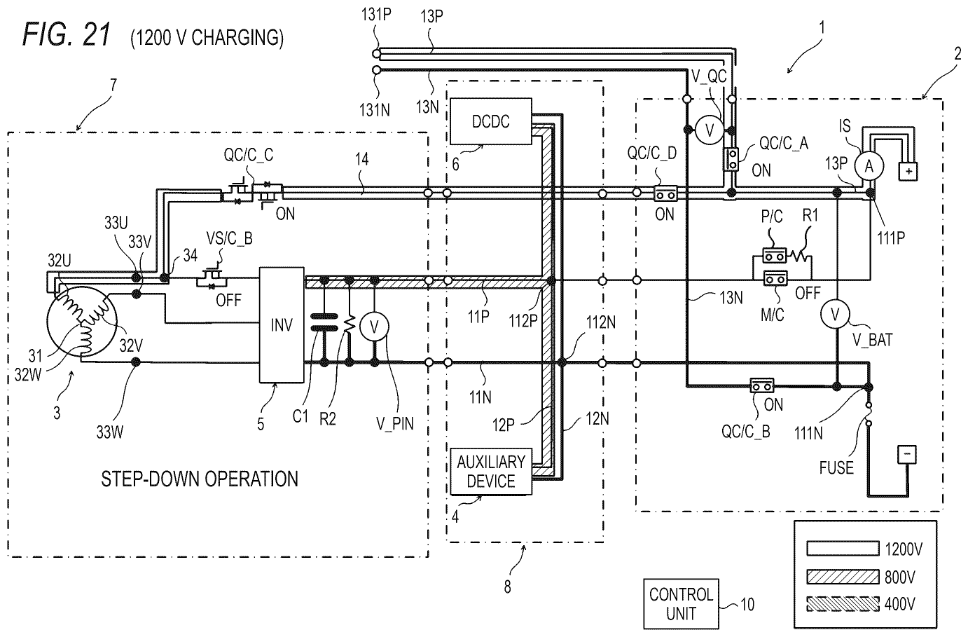

FIG. 21 is a diagram showing a flow of a current during charging at the third voltage (1200 V charging) of the electric vehicle including the power storage system 1 according to the second embodiment.

When charging with a 1200 V class charging equipment, the battery 2 is controlled to a 1200 V start-up state shown in FIG. 6. The control unit 10 turns on the third contactor QC/C_A, the fourth contactor QC/C_B, the first semiconductor switch QC/C_C (second switch unit 42), and the fifth contactor QC/C_D, and turns off the first contactor M/C (third switch unit 43) and the second semiconductor switch VS/C_B (fourth switch unit 44). A circuit mode in this case is called a twelfth mode. As a result, a voltage of 1200 V is supplied from the charge terminals 131P and 131N to the battery 2, and a voltage of 1200 V is supplied via the branch circuit 14 to the coil 32U.

Here, in order to drive the auxiliary device 4 having a base voltage of 800 V, it is necessary to step down the voltage of 1200 V to 800 V, which is the base voltage of the auxiliary device 4. The step-down operation is as explained in the first embodiment with reference to FIGS. 13 and 14, and detailed explanation thereof will be omitted. By the step-down operation, the voltage of 1200 V supplied from the charge terminals 131P and 131N is stepped down to 800 V and supplied from the inverter 5 to the auxiliary device 4.

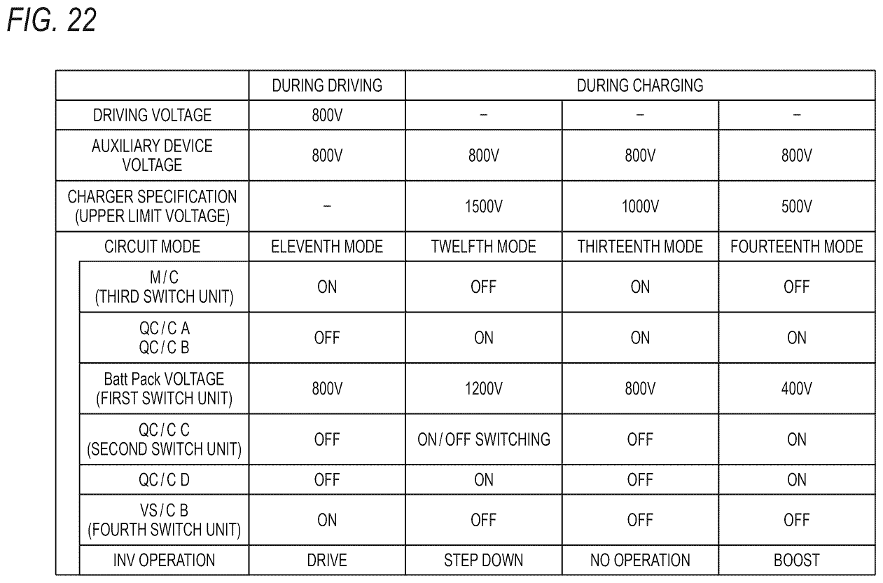

FIG. 22 is a table summarizing the states of the switches and the contactors in each mode of the power storage system 1 of the second embodiment.

In this way, similar to the first embodiment, according to the power storage system 1 of the second embodiment, regardless of whether the external charging equipment is a system that charges at the first voltage (400 V charging), a system that charges at the second voltage (800 V charging), or a system that charges at the third voltage (1200 V charging), a connection method of the plurality of power storage units 21 can be switched using the first switch unit 41 (S/C_A, S/C_B, S/C_C, S/C_D, S/C_E, S/C_F, S/C_G, S/C_H), thereby enabling appropriate charging according to the voltage state of the charging equipment. That is, charging can be performed without passing through any voltage converter during charging, efficiency deterioration due to a voltage converter can be avoided, and it is possible to eliminate a voltage converter for charging.

Since the DC power supply circuit 13P on the positive electrode side connected to the first connection portion 111P positioned on the electric power transmission path between the inverter 5 and the battery 2 includes the branch circuit 14 connected to a coil of any one phase of the three-phase motor 3, voltage conversion can be performed using the three-phase motor 3 and the inverter 5. Especially, by providing the first semiconductor switch QC/C_C (second switch unit 42) and the second semiconductor switch VS/C_B (fourth switch unit 44), it is possible to not only boost but also step down the voltage by utilizing the coils of the three-phase motor 3, even when the voltage state of the charging equipment and the operating voltage of the auxiliary device 4 are different from each other. In this way, a dedicated voltage converter can be eliminated, thereby reducing the manufacturing cost.

Although the various embodiments have been described above with reference to the drawings, it is needless to say that the present invention is not limited to these examples. It is apparent that those skilled in the art can conceive of various modifications and changes within the scope described in the claims, and it is understood that such modifications and changes naturally fall within the technical scope of the present invention. In addition, the constituent elements in the above embodiments may be freely combined without departing from the gist of the invention.

For example, in the above embodiments, the control unit 10 has been described as communicating with the charging equipment, but the communication method may be any communication method such as CAN communication.

In the present description, at least the following matters are described. In the parentheses, the corresponding constituent elements and the like in the above embodiment are shown, but the present invention is not limited thereto.

(1) A power storage system (power storage system 1) including:
a battery (battery 2) including a plurality of power storage units (power storage units 21), and a switch group (first switch unit 41) capable of switching a connection state of the plurality of power storage units between a first voltage state capable of charging at a first voltage (400 V), a second voltage state capable of charging at a second voltage (800 V) higher than the first voltage, and a third voltage state capable of charging at a third voltage (1200 V) higher than the second voltage;
a three-phase motor (three-phase motor 3) in which coils of three phases (coils 32U, 32V, 32 W) are connected at a neutral point (neutral point 31), the three-phase motor being driven by electric power supplied from the battery;
an inverter (inverter 5) connected on an electric power transmission path (electric power supply circuits 11P, 11N) between the battery and the three-phase motor; and
a DC power supply circuit (DC power supply circuits 13P, 13N) connected to a first connection portion (first connection portions 111P, 111N) positioned on an electric power transmission path between the inverter and the battery, in which
the DC power supply circuit on a positive electrode side has a branch circuit (branch circuit 14) connected to a coil of any one phase among the coils of three phases at a second connection portion (connection portion 34) via a first semiconductor switch (first semiconductor switch QC/C_C), and
a second semiconductor switch (second semiconductor switch VS/C_B) is provided between the second connection portion and the inverter in a coil of any one phase among the coils of three phases.

According to (1), it is possible to appropriately perform charging according to a voltage state of charging equipment by switching, by the switch group, a connection method of the plurality of power storage units regardless of whether the external charging equipment is a system that performs charging at the first voltage, a system that performs charging at the second voltage, or a system that performs charging at the third voltage. That is, charging can be performed without passing through any voltage converter during charging, efficiency deterioration due to a voltage converter can be avoided, and it is possible to eliminate a voltage converter for charging.

Since the DC power supply circuit on the positive electrode side connected to the first connection portion positioned on the electric power transmission path between the inverter and the battery includes the branch circuit connected to a coil of any one phase among the three-phase motor, voltage conversion can be performed using the three-phase motor and the inverter. Especially, by providing the first semiconductor switch and the second semiconductor switch, it is possible to not only boost but also step down the voltage by utilizing the coils of the three-phase motor, even when the voltage state of the charging equipment and the operating voltage of the auxiliary device are different from each other. In this way, a dedicated voltage converter can be eliminated, thereby reducing the manufacturing cost.

(2) The power storage system according to (1), further including:
an auxiliary device configured to be driven by DC power from the battery and an external power supply; and
an auxiliary device drive circuit connected on an electric power transmission path between the inverter and the first connection portion, and configured to supply electric power to the auxiliary device, in which
the auxiliary device is operated at the second voltage.

According to (2), when charging at the second voltage and when traveling at the second voltage, voltage conversion is not required.

(3) The power storage system according to (2), further including:
a control unit (control unit 10) configured to control the switch group, the first semiconductor switch, the second semiconductor switch, and the inverter, wherein
the control unit controls the inverter to boost the first voltage to generate the second voltage when the battery is charged with the first voltage, and
the control unit controls the first semiconductor switch, the second semiconductor switch, and the inverter to step down the third voltage to generate the second voltage when the battery is charged with the third voltage.

According to (3), no matter a system that charges at the first voltage or a system that charges at the third voltage is used, the auxiliary device can be driven at the second voltage, so that an amount of voltage conversion when boosting and stepping down can be reduced. In this way, it is possible to prevent the system from becoming larger.

(4) The power storage system according to (2) or (3), in which
the auxiliary device is connected to the battery via a switch unit (third switch unit 43).

According to (4), when charging with the first voltage or the third voltage, the switch unit can separate portions at the first voltage state and the third voltage state from a portion at the second voltage state.

### REFERENCE SIGNS LIST

1 power storage system
2 battery
3 three-phase motor
5 inverter
10 control unit
14 branch circuit
21 power storage unit
31 neutral point
34 connection portion (second connection portion)
41 first switch unit (switch group)
43 third switch unit (switch unit)
VS/C_B second semiconductor switch (second semiconductor switch)
QC/C_C first semiconductor switch (first semiconductor switch)

What is claimed is:

1. A power storage system comprising:
a battery including a plurality of power storages, and a switch group capable of switching a connection state of the plurality of power storages between a first voltage state capable of charging the plurality of power storages at a first voltage, a second voltage state capable of charging the plurality of power storages at a second voltage higher than the first voltage, and a third voltage state capable of charging the plurality of power storages at a third voltage higher than the second voltage;
a three-phase motor in which coils of three phases are connected at a neutral point, the three-phase motor being driven by electric power supplied from the battery;
an inverter connected on an electric power transmission path between the battery and the three-phase motor; and
a DC power supply circuit connected to a first connection portion positioned on an electric power transmission path between the inverter and the battery, wherein
the DC power supply circuit on a positive electrode side has a branch circuit connected to a coil of one phase among the coils of three phases at a second connection portion via a first semiconductor switch, and
a second semiconductor switch is provided, between the second connection portion and the inverter, in a coil of one phase among the coils of three phases.

2. The power storage system according to claim 1, further comprising:
an auxiliary device which is capable of being driven by DC power from the battery or an external power supply; and
an auxiliary device drive circuit connected on an electric power transmission path between the inverter and the first connection portion, and configured to supply electric power to the auxiliary device, wherein
the auxiliary device is operated at the second voltage.

3. The power storage system according to claim 2, further comprising:
a controller configured to control the switch group, the first semiconductor switch, the second semiconductor switch and the inverter, wherein
the controller controls the inverter to boost the first voltage to generate the second voltage when the battery is charged with the first voltage, and
the controller controls the first semiconductor switch, the second semiconductor switch and the inverter to step down the third voltage to generate the second voltage when the battery is charged with the third voltage.

4. The power storage system according to claim 2, wherein
the auxiliary device is connected to the battery via a switch.

5. The power storage system according to claim 3, wherein
the auxiliary device is connected to the battery via a switch.
